(19) United States
(12) Patent Application Publication
(10) Pub. No.: US 2025/0222806 A1
(43) Pub. Date: Jul. 10, 2025

(54) METHOD FOR DETECTING THE RELATIVE POSITION OF A STATIONARY INDUCTION CHARGING DEVICE TO A MOBILE INDUCTION CHARGING DEVICE

(71) Applicant: MAHLE International GmbH, Stuttgart (DE)

(72) Inventor: Mike Boettigheimer, Kornwestheim (DE)

(21) Appl. No.: 18/854,544

(22) PCT Filed: Apr. 6, 2023
(86) PCT No.: PCT/EP2023/059096

§ 371 Date: Oct. 6, 2024

(30) Foreign Application Priority Data
Apr. 7, 2022 (DE) 10 2022 203 482.1

(51) Int. Cl. B60L 53/39; B60L 53/122; B60L 53/36; H02J 50/10; H02J 50/90

(52) U.S. Cl. CPC B60L 53/39; B60L 53/122; B60L 53/36; H02J 50/10; H02J 50/90

(57) ABSTRACT

A method for detecting the relative position of a stationary induction charging device to a mobile induction charging device may include providing, in a first induction charging device, at least two distinguishable positioning fields. The method may further include receiving the at least two positioning fields in a second induction charging device, determining a ratio between the at least two positioning fields, and recognizing that a first power coil of the first induction charging device and a second power coil of the second induction charging device are arranged in a virtual frame volume and overlap transversely to a vertical direction when the determined ratio lies in a predetermined ratio range. The virtual frame volume may be bounded by at least two intensity maximums of the at least two positioning fields and may extend in the vertical direction.

### CROSS-REFERENCE TO RELATED APPLICATIONS

This application claims priority to International Patent Application No. PCT/EP2023/059096, filed on Apr. 6, 2023, and German Patent Application No. DE 10 2022 203 482.1, filed on Apr. 7, 2022, the contents of both of which are hereby incorporated by reference in their entirety.

### TECHNICAL FIELD

The present invention relates to a method for detecting the relative position of a stationary induction charging device to a mobile induction charging device, which interact with each other in a charging mode for inductive energy transmission. The invention also relates to a computer program product for executing the method, a system with a stationary induction charging device and a mobile induction charging device that is operated according to the method, as well as a mobile application, in particular a motor vehicle, with a mobile induction charging device of such a system and a stationary induction charging device of such a system.

### BACKGROUND

A system for inductive energy transfer usually has a stationary and a mobile induction charging device. In a charging mode, a power coil of one of the induction charging devices acts as a primary coil and the power coil of the other induction charging device acts as a secondary coil. Such systems are typically used for inductive power transfer to a mobile application, for example a motor vehicle, wherein the mobile application has the mobile induction charging device. In mobile applications, the power coil of the mobile induction charging device is usually the secondary coil in charging mode. For inductive energy transmission, the primary coil generates an alternating magnetic field that induces a voltage in the secondary coil. To enable inductive energy transfer and to increase the efficiency of inductive energy transfer, the primary coil and the secondary coil, and thus the power coils of the induction charging devices, are to be positioned relative to each other accordingly.

In EP 2 727 759 B1, a transmitter and a receiver are used to detect the relative position of a mobile induction charging device mounted on a motor vehicle.

DE 10 2012 205 283 A1 proposes using an even number of detector coil elements that are wound in opposite directions in pairs to form a detector pair.

In EP 3 347 230 B1, a mobile induction charging device is proposed that uses a transmitter unit that emits a transmission signal at a predetermined frequency during operation. The transmission signal with the specified frequency is received with a receiving unit and a signal part of the transmission signal is determined. A relative position is determined depending on the signal component detected.

DE 10 2017 215 932 B3 describes a method for determining the position of a motor vehicle on an underground. The motor vehicle has a mobile induction charging device. When the power coil of the mobile induction charging device is energized, at least one magnetic structure arranged in or on a substrate traversed by the motor vehicle is magnetized. The structure is stored in a digital map together with the position of the respective structure in a digital map, wherein the position of the motor vehicle is determined on the basis of the magnetized structure.

### SUMMARY

The present invention is concerned with the task of specifying improved or at least different embodiments for a method for detecting the relative position of a stationary induction charging device to a mobile induction charging device, for a computer program product for executing the method, for a system operated in such a way with a stationary induction charging device to a mobile induction charging device, as well as a mobile application with a mobile induction charging device of such a system and for a stationary induction charging device of such a system, which in particular eliminate disadvantages from the prior art. In particular, the present invention is concerned with the task of providing improved or at least different embodiments for the method, for the computer program product, for the system, and for the mobile application and for the stationary induction charging device, which are characterized by increased precision and/or increased robustness of the detection of the relative positioning of the system's power coils.

According to the invention, this task is solved by the subject matter of the independent claim(s). Advantageous embodiments are the subject matter of the dependent claim(s).

The present invention is therefore based on the general idea of generating at least two fields, distinguishable from one another and fixed relative to the power coil, for one of the power coils in order to detect the relative position between two power coils, which fields are received at a position fixed to the other power coil, wherein the relative position of the two power coils to one another is detected on the basis of the ratio between the received fields. Due to the fixed arrangement of the fields for one power coil on the one hand and the reception of the fields at a point fixed to the other power coil on the other hand, the ratio changes depending on the relative position of the power coils to each other. Thus, for example, the power coils are arranged to overlap at a predetermined ratio of the fields to each other. In this way, the relative position of the power coils and, in particular, an overlapping arrangement of the power coils in relation to each other can be determined simply and effectively. Since the relative position of the power coils is determined by the ratios of the fields, a reliable and simple determination of the relative position is ensured, especially in comparison to the determination of absolute values of fields or differences in transit times of at least one field, which is known from the state of the art. This is particularly due to the fact that the ratio of the received fields does not change, or only changes slightly, with a distance that varies in the vertical direction. Thus, for example, mobile induction charging devices in associated applications at different heights and/or stationary induction charging devices can be installed or arranged at different heights or depths and the relative position of the power coils to each other can still be recognized without further calibration.

Using the ratio to determine the relative position of the power coils has the particular advantage, as explained, that repeated calibration of induction charging devices that transfer energy inductively to one another can be dispensed with. This means that at least one ratio can be specified in advance, wherein when such a ratio is determined from the received fields, it is recognized that the power coils are in the corresponding relative position to one another. In this way, it is possible, in particular, to transfer the said predetermined ratios from the induction charging device generating the fields to the receiving induction charging device, either once only, preferably before the positioning starts, in order to determine the relative position of the power coils to one another. Alternatively, and preferably, the ratios are fixed, so the given ratio is stored in the receiving induction charging device and thus no transmission to the receiving induction charging device is necessary. This allows, in particular, the relative position between the power coils of different stationary induction charging devices and different mobile induction charging devices to be determined in a simple and robust manner without prior calibration.

In accordance with the inventive concept, a method is provided for detecting the relative position of a stationary induction charging device to a mobile induction charging device, wherein the stationary induction charging device has a stationary power coil and the mobile induction charging device has a mobile power coil. In charging mode, the power coils are spaced apart in a vertical direction. During charging mode, one of the power coils generates an alternating magnetic field that induces a voltage in the other power coil for the purpose of energy transmission. In the charging mode, the power coils are spaced apart from each other in a vertical direction. To detect the relative position of the power coils to each other, at least two fields are generated in one of the induction charging devices, which are also referred to below as positioning fields. The positioning fields are generated in such a way that they can be distinguished from one another, and in such a way that the power coil of the associated induction charging device, that is to say the induction charging device that generates the positioning fields, is fixed in position relative to the positioning fields. Furthermore, the positioning fields are generated in such a way that the power coil lies at least partially in a virtual frame volume that extends in the vertical direction and is bounded by at least two intensity maximums of at least two of the positioning fields. The positioning fields are received at least one position fixed to the power coil of the other induction charging device. A ratio range is specified in advance for the local ratio between at least two of the approach fields. The specified ratio range is such that the power coil of the induction charging device receiving the positioning fields is located in the frame volume. This means that a ratio range of at least two of the received positioning fields is specified in advance, for which the power coil of the induction charging device receiving the positioning fields is arranged in the frame volume. To determine the relative position of the power coils to each other, the ratio between at least two of the received positioning fields is determined. It is recognized that the power coils are arranged in the frame volume and overlap transversely to the vertical direction if at least one of the at least one determined ratio lies within the associated predetermined ratio range.

The relative position of the power coils to one another is advantageously detected by comparing at least one determined ratio with the associated ratio range.

At least one ratio range is preferably stored. This simplifies the implementation of the method.

It is useful if at least two of the positioning fields, and in particular all of them, overlap in the frame volume.

The positioning can include an approach of the power coils to each other as well as a precise positioning of the power coils to each other, hereinafter also referred to as near-field positioning. The positioning device described here is used for near-field positioning. Near-field positioning is used to advantage when the power coils are spaced less than 1.0 m, preferably less than 0.5 m, apart, in order to position them precisely in relation to each other. At least a proximity field can be used to bring the power coils closer together.

The respective power coil preferably has at least one winding. In the context of the present invention, the term “extension of the power coil” is to be understood in particular as referring to the entire surface spanned by the at least one winding. In the case of a flat coil, the central range, in which there can be no winding, also belongs to the power coil.

The positioning fields can be generated in any way in the induction charging device that generates the positioning fields.

At least one of the positioning fields, preferably the respective positioning field, is a magnetic and/or electromagnetic field.

At least one of the positioning fields is preferred, preferably the respective positioning field, a magnetic field. This means that at least one of the positioning fields, preferably the respective positioning field, is generated as a magnetic positioning field. A magnetic positioning field has the advantage over an electromagnetic positioning field that the receiver receives the positioning field in a simplified and reliable manner. Furthermore, this method makes it possible to dispense with a calibration, which is usually required, for example, for differences in transit time, as they usually occur in electromagnetic and/or acoustic fields. The magnetic positioning field thus provides a simplified and robust method of determining the ratios and thus the relative position of the power coils to each other. In particular, the elimination of the calibration performed during the respective positioning also means that the positioning can be carried out between different induction charging devices. In other words, the use of magnetic positioning fields makes it possible to easily implement positioning with different induction charging devices.

A main axis of the respective positioning field preferably runs along the vertical direction. The respective positioning field thus propagates at least predominantly in or along the vertical direction and can therefore only be received transversely to the vertical direction locally in the area of the associated transmitting coil and power coil, i.e. essentially on or in the immediate vicinity of the power coil. Thus, the positioning fields are used to determine the relative position locally and thus close to the stationary induction charging device, i.e. when the mobile induction charging device has already approached the stationary induction charging device. The advantage of such main axes is, on the one hand, that the relative position is determined more precisely, especially because the respective volume is more precisely defined. On the other hand, this prevents or at least reduces overlaps between positioning fields of adjacent induction charging devices transverse to the vertical direction, for example of adjacent stationary induction charging devices. The latter in turn leads to a more precise determination of the relative position and to simplified, interference-reduced and reliable operation of several adjacent induction charging devices, for example of adjacent stationary induction charging devices.

An advantage is provided for the respective positioning field a coil, which is hereinafter also referred to as a transmitting coil. Thus, the induction charging device, which generates at least two positioning fields, preferably has at least two transmitting coils, namely one transmitting coil for each respective positioning field.

The main axis of a positioning field running along the vertical direction is advantageously achieved by winding the associated transmitting coil around a winding axis running parallel or essentially parallel to the vertical direction. The transmitting coil therefore has at least one conductor track through which current flows during operation, which is wound around the winding axis that runs parallel or essentially parallel to the vertical direction.

At least one of the transmitting coils may be the power coil of the associated induction charging device.

Preferably, the transmitting coils are different from the power coil of the associated induction charging device.

The position of the positioning fields, in particular the intensity maximums, fixed to the power coil, can be achieved in any way.

The advantage of the fixed position of the positioning fields, in particular the intensity maximums in relation to the power coil of the associated induction charging device is achieved by appropriate positioning of the transmitting coils.

In principle, the relative position of the power coils can be detected during the charging mode.

Preferably, the relative position of the power coils to one another is detected outside of the charging mode, that is, in an operating mode that is different from the charging mode, which will be referred to in the following as the positioning operation.

Positioning operation is favorably received and started when the distance between the induction charging devices is less than a predetermined distance, perpendicular to the vertical direction.

A ping signal is transmitted from one of the induction charging devices, preferably from the mobile induction charging device, which is received by the other induction charging device, wherein the positioning operation is started when the ping signal is received.

The positioning operation is terminated when the power coils are aligned with each other. When the power coils are aligned with each other, charging mode can begin.

The receiving of the positioning fields in the other induction charging device can be done in any way.

The induction charging device receiving the positioning fields advantageously has at least one receiver that is fixed relative to the associated power coil and interacts with the positioning fields of the other induction charging device.

In particular, it is conceivable that the induction charging device has a single such receiver.

In principle, the respective at least one receiver can be designed as required.

For example, at least one of the at least one receiver can have at least one coil, hereinafter also referred to as a receiving coil. It is conceivable that at least one of the at least one receiver is such a receiving coil.

At least one of the at least one receiving coil can correspond to the power coil of the associated induction charging device. This means that the power coil of the induction charging device can be used as a power coil during charging mode and as a receiving coil during positioning, i.e. in detection mode.

Advantageously, the power coil of the receiving induction charging device is different from the at least one receiving coil.

The induction charging devices are used for inductive energy transmission, wherein one of the power coils acts as a primary coil and the other power coil acts as a secondary coil during charging mode. In particular, energy is inductively transferred from the stationary induction charging device to the mobile induction charging device. Variants are also conceivable in which the mobile induction charging device transfers energy inductively to the stationary induction charging device. A bidirectional transfer of energy is also conceivable.

The mobile induction charging device is preferably attached to an associated mobile application, in particular to a motor vehicle. Preferably, energy is transferred inductively to the application by means of the mobile induction charging device, for example to charge a battery of the application, in particular of the motor vehicle.

In the case of preferred embodiments, a tolerance is permitted for at least one of the at least one ratio range. This makes it possible, in particular, to use the same stationary induction charging device with mobile induction charging devices that are arranged at different heights in the associated application, i.e. for different distances in the vertical direction. In particular, it is thus possible to achieve reliable and robust detection of the relative position of the power coils to one another when using the mobile induction charging device in vehicles of different heights, for example in a sports car, an SUV or a truck.

Alternatively or additionally, it is conceivable for this purpose to predetermine corresponding ratio ranges for different distances between the power coils in the vertical direction during charging mode.

Embodiments are considered advantageous in which a virtual target volume extending in the vertical direction is defined within the frame volume, such that the power coil of the induction charging device generating the positioning fields is at least partially located in the target volume. In addition, at least one of the ratio ranges is specified in such a way that the power coil of the induction charging device receiving the positioning fields is arranged in the target volume. If a ratio is determined in the ratio range belonging to the target volume, it is recognized that the power coils within the target volume overlap transversely to the vertical direction. Since the target volume is smaller than the frame volume, this results in increased precision in the detection of the relative position of the power coils to each other. This also makes it possible to align the power coils more precisely in relation to each other.

In principle, the frame volume and/or the target volume can be chosen as desired.

The frame volume and the target volume are chosen so that a high degree of efficiency is achieved during charging mode when the power coils overlap within the frame volume or the target volume.

The frame volume and/or the target volume is/are preferably selected such that, with an overlapping arrangement of the power coils within the volume during charging mode, an efficiency of at least 90% is achieved.

In doing so, the respective ratio ranges can be assigned to the frame volume and the target volume. At least one of the ratio ranges assigned to the target volume is narrower than at least one of the ratio ranges assigned to the frame volume.

For example, at least one of the at least one ratio ranges associated with the target volume can be between 1:0.1 and 0.1:1.

For example, at least one of the at least one ratio ranges associated with the frame volume can be between 10:0.05 and 0.05:10.

In preferred embodiments, at least two of the opposing intensity maximums are assigned a direction. This allows in particular to recognize that the power coils overlap in direction.

Accordingly, preferred are embodiments in which the positioning fields are generated in such a way that the intensity maximums of at least two positioning fields are arranged opposite one another in a longitudinal direction running transversely to the vertical direction, wherein these positioning fields are also referred to below as longitudinal positioning fields. Furthermore, a corresponding ratio range is specified in advance for at least two of the longitudinal positioning fields, which is also referred to below as the longitudinal ratio range. A ratio is determined from the received positioning fields between at least two of the longitudinal positioning fields, which is also referred to below as the longitudinal ratio. If the determined longitudinal ratio is within the associated specified longitudinal ratio range, it is recognized that the power coils overlap in the longitudinal direction.

Accordingly, preferred are embodiments in which the positioning fields are generated in such a way that the intensity maximums of at least two positioning fields are arranged opposite one another in a transverse direction running transversely to the vertical direction, wherein the positioning fields are also referred to below as transverse positioning fields. In addition, a corresponding ratio range is specified in advance for at least two of the transverse positioning fields, which is subsequently also referred to as the transverse ratio range. A ratio between at least two of the transverse positioning fields is determined from the received positioning fields, which is also referred to below as the transverse ratio. As long as the determined transverse ratio lies within the associated prescribed transverse ratio range, it is recognized that the power coils overlap in the transverse direction.

It is preferable if at least two longitudinal positioning fields and at least two transverse positioning fields are generated, wherein an associated transverse ratio range is predefined for at least two longitudinal positioning fields and an associated transverse ratio range is predefined for at least two transverse positioning fields, and wherein at least one longitudinal ratio and at least one transverse ratio are determined from the received positioning fields. This leads to increased precision in recognizing the relative position of the power coils to one another.

Accordingly, it is preferred if an overlap of the power coils is detected, provided that the determined longitudinal ratio lies within the associated predetermined longitudinal ratio range and if the determined transverse ratio lies within the associated predetermined transverse ratio range.

The longitudinal and transverse directions are at an appropriate angle to each other. The longitudinal direction and the transverse direction are at least inclined to each other.

The preferred orientation is with the longitudinal and transverse directions at right angles to each other. This allows for a simplified detection of the relative position of the power coils to each other. In addition, the overlapping arrangement of the power coils can be implemented in a simplified manner by moving the induction charging devices relative to each other.

When using the mobile induction charging device in a motor vehicle, it is preferable for the longitudinal direction to correspond to the X-direction and the transverse direction to correspond to the Y-direction of the motor vehicle, or vice versa.

It is conceivable to generate the longitudinal positioning fields in the stationary induction charging device and to receive them in the mobile induction charging device, and to generate the transverse positioning fields in the mobile induction charging device and to receive them in the stationary induction charging device, or vice versa.

In preferred embodiments, all positioning fields are generated in one induction charging device and received in the other induction charging device. This simplifies the implementation of the method.

Preferred embodiments are those in which the positioning fields are generated in such a way that two pairs of intensity maximums are arranged opposite each other at a distance from each other in the longitudinal direction and/or two pairs of intensity maximums are arranged opposite each other at a distance from each other in the transverse direction. Thus, two ratios or associated ratio ranges are available for detecting the overlapping arrangement of the power coils in the longitudinal and/or transverse direction. This leads to increased precision in recognizing the relative position of the power coils to one another.

It is preferable for the positioning fields to be generated in such a way that two pairs of intensity maximums are arranged opposite each other at a distance from each other in the longitudinal direction and two pairs of intensity maximums are arranged opposite each other at a distance from each other in the transverse direction.

The ratio of the two positioning fields exhibiting the opposite intensity maximums is determined favorably and, in the event of a deviation of the ratios above a predetermined limit value for detecting the relative position, the ratio of the positioning fields with the lower intensity is used. Since the intensity maximum of the respective positioning field exhibits a local course in the form of a double hump, it is thus avoided that determined ratios between the two humps are used to recognize the relative position of the power coils to each other. As a result, distortions in the detection of the relative position of the power coils to each other.

The ratio of the two positioning fields exhibiting the opposite intensity maximums is advantageously determined and, if the ratios match within a predefined range, the two ratios are averaged to recognize the relative position. This leads to increased accuracy and robustness in detecting the relative position of the power coils.

In particular, a correlation between the two ratios means that the two ratios are essentially the same or within a given range of averages.

Four transmitting coils are used to generate the longitudinal and the transverse positioning fields. However, it is understood that more than four positioning fields and thus transmitting coils can be used.

The transmitting coils are preferably arranged in the corners of a rectangle. Thus, the positioning field generated by the respective transmitting coil is both a transverse positioning field and a longitudinal positioning field. This leads to a simplified design of the induction charging device with the transmitting coils.

In the case of advantageous embodiments, if the determined ratio deviates from the associated ratio range towards an intensity maximum of one of the associated positioning fields, an offset of the power coil of the induction charging device receiving the positioning fields with respect to the power coil of the induction charging device generating the positioning fields is detected towards that intensity maximum to which the determined ratio is offset. Thus, not only is the offset of the power coils from one another detected, but also the direction of the offset. In addition to increased precision in the detection of the relative position of the power coils to one another, it is thus possible to perform a relative movement of the mobile induction charging device to the stationary induction charging device in such a way that this offset is eliminated. This means that in this way a simplified corresponding navigation of the mobile induction charging device, or the associated application is made possible.

A positioning signal is output as a function of the value determined for at least one determined ratio with respect to the associated ratio range.

The positioning signal can be used via an output device as a guide for a person navigating the mobile induction charging device and/or the associated application and/or as a control signal for automated navigation of the mobile induction charging device and/or the associated application in such a way that the navigation leads to an arrangement of the power coils that overlaps overall transversely to the vertical direction.

Preferably, the positioning fields are generated in such a way that, for a given centering-to-length ratio in the longitudinal ratio range, the power coils are centered in the longitudinal direction. In this way, an overlapping arrangement of the power coils centered in the longitudinal direction can be detected and/or navigation to such an arrangement can be achieved more easily.

Alternatively or additionally, preferably additionally, the positioning fields are generated in such a way that, for a given centering-to-transverse ratio in the transverse ratio range, the power coils are arranged centered to one another in the transverse direction. This means that a transversely centered overlapping arrangement of the power coils can be detected and/or navigation to such an arrangement can be achieved more easily.

In total, it is thus possible to achieve an overall centered arrangement of the power coils in relation to each other perpendicular to the vertical direction. This results in increased efficiency during charging mode.

In principle, the respective centering ratio can be selected as desired. In particular, at least one of the centering ratios can be 1:1 or essentially 1:1. This makes it easier to see the centered arrangement and/or to navigate to the centered arrangement.

In preferred embodiments, the positioning fields are generated in such a way that at least one of the ratio ranges, preferably the respective ratio range, is spaced apart from the intensity maximums of the associated positioning fields. This means that the intensity maximums lie outside at least one of the at least one ratio ranges, preferably outside all ratio ranges. Since the intensity maximum of the respective positioning field has a local course in a double-hump shape, as explained above, it is thus avoided that determined ratios between the two humps are used to recognize the relative position of the power coils to each other. As a result, distortions in the detection of the relative position of the power coils to each other.

In principle, at least two of the positioning fields can be generated with different intensity curves.

In favorable embodiments, positioning fields with the same intensity curves are generated. This makes it possible to operate the induction charging device that generates the positioning fields and/or to simplify the reception and/or differentiation of the positioning fields.

It is preferable to generate the positioning fields in such a way that the overall intensity curve of the positioning fields is symmetrical to the power coil of the induction charging device generating the positioning fields. Thus, the symmetry of the overall intensity curve can be used to easily identify the relative position of the power coils to one another and/or to simplify navigation towards a centered arrangement.

In principle, the generation of the positioning fields, in such a way that they are distinguishable from one another, can be done in any way.

In particular, it is conceivable that the positioning fields are generated at different frequencies so that the positioning fields can

It is advantageous to generate positioning fields with frequencies in the range between 5 kHz and 150 kHz. Preference is given to the generation of positioning fields with frequencies between 110 kHz and 148.5 kHz, particularly between 120 kHz and 145 kHz.

The frequencies associated with the transmitting coils are preferably spaced as closely together as possible so that the total frequency spectrum required is small The frequencies are, for example, 5 kHz or 1 kHz or 100 Hz or 1 or a few hertz apart.

Alternatively or additionally, it is conceivable to generate the positioning fields with their associated degrees of keying so that the positioning fields can be distinguished. The distinction between the positioning fields is therefore made by means of so-called “duty cycles”. The use of duty cycles means that the positioning fields can be generated with the same frequency or the same frequency band. This means that fewer frequencies are needed. This also results in particular in a reduced influence of the positioning device on nearby components.

In the preferred embodiments, the positioning fields are generated in the stationary induction charging device and received in the mobile induction charging device. Since a relative movement of the mobile induction charging device to the stationary induction charging device takes place in order to align the power coils with one another, the determination of the at least one ratio and the detection of whether the power coils overlap can thus take place in the mobile induction charging device. Compared to a corresponding determination in the stationary induction charging device and a transfer to the mobile induction charging device or the associated application, the results are thus available in the mobile induction charging device or in the application. In other words, this prevents, or at least reduces, latency in the detection of the relative position of the power coils to one another. This results in particular in smooth navigation of the mobile induction charging device or the application that has the mobile induction charging device.

The method according to the invention can be used to detect the relative position of the power coils at any distance from each other. In particular, the method according to the invention can be used for navigating and aligning the power coils in relation to each other in any distance range.

The method is advantageous for detecting the relative position and/or for navigation in the so-called near field, i.e. at distances of less than 1.5 m, preferably less than 1.0 m, in particular less than 0.5 m.

Induction charging device is usually part of a system.

In the system, the mobile induction charging device is preferably attached to an associated mobile application, in particular to a motor vehicle.

The method can be carried out by a computer program product that is designed accordingly.

The computer program product for detecting the relative position between the power coils of the stationary induction charging device and the mobile induction charging device advantageously contains instructions that can be read out by a computer system, such that the computer system executes the method when the computer program product is executed.

The computer program product is advantageously stored on a storage system having at least one non-volatile memory.

The computer program product advantageously contains instructions that cause the system to carry out the method.

It is understood that the computer program product is also included in the scope of this invention.

It is also understood that the system is also part of the scope of this invention. To carry out the method, the system can be equipped with a control device with the appropriate design.

The control device can at least partially contain the computer program product and/or at least partially comprise the computer system.

It is also understood that a mobile application, in particular a motor vehicle, with the mobile induction charging device of such a system also belongs to the scope of this invention.

Other important features and advantages of the invention can be seen from the dependent claims, from the drawings and from the associated description of the figure based on the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown in the images, in each case systematically:

FIG. 1 shows a highly simplified representation of a system for inductive energy transfer,

FIG. 2 shows a schematic representation of virtual volumes,

FIG. 3 shows a simplified plan view of a stationary induction charging device of the system,

FIG. 4 shows a cross-section of the stationary induction charging device,

FIG. 5 shows a diagram with positioning fields,

FIG. 6 shows a simplified plan view of the system's transmitting coils and receiver,

FIG. 7 shows a diagram with positioning fields from the receiver receiving,

FIG. 8 shows a diagram with other positioning fields receiving from the receiver,

FIG. 9 shows a flowchart explaining the detection of the relative position of the power coils of a mobile induction charging device and a stationary induction charging device,

FIG. 10 shows a plan view of a power coil of an induction charging device with transmitting coils.

### DETAILED DESCRIPTION

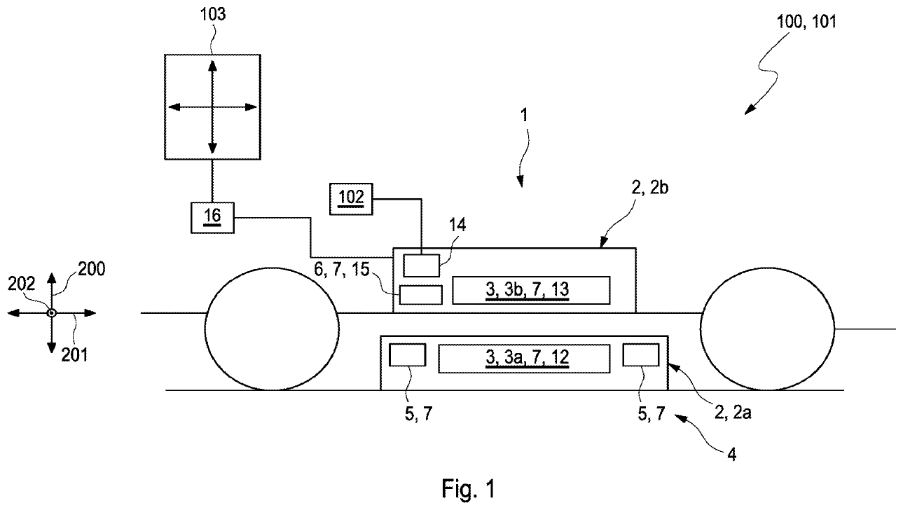

A system 1, as shown in FIG. 1 in a highly simplified and circuit-diagrammatic manner, is used for inductive power transfer to a mobile application 100, in particular for charging a battery 102 of the mobile application 100. In the exemplary embodiment shown, the application 100 is a motor vehicle 101. For this purpose, system 1 has two induction charging devices 2 that interact inductively with each other during charging mode, namely a stationary induction charging device 2, 2a and a mobile induction charging device 2, 2b for application 100. For inductive energy transmission during charging mode, the respective induction charging device 2 has an associated coil 3. These coils 3 are also referred to below as power coils 3. Thus, the stationary induction charging device 2, 2a has a stationary power coil 3, 3a and the mobile induction charging device 2, 2b has a mobile power coil 3, 3b. One of the power coils 3 thus serves as a primary coil 12 in charging mode, which generates an alternating magnetic field that induces a voltage in the other power coil 3 serving as a secondary coil 13 for energy transmission. In the exemplary embodiments shown, the power coils 3 are each designed as a flat coil 7. In charging mode, the induction charging devices 2 are spaced 200 apart in the vertical direction. To enable charging mode and to achieve high charging efficiencies, the power coils 3 are positioned relative to one another perpendicular to the vertical direction 200, that is, in a longitudinal direction 201 running perpendicular to the vertical direction 200 and in a transverse direction 202 running perpendicular to the vertical direction 200 and the longitudinal direction 201. For this purpose, the relative position of the power coils 3 to one another is recognized. This is best done before charging in order to achieve an optimal relative positioning of the power coils 3 to each other and thus an increased efficiency.

In the exemplary embodiments shown, energy is transferred from the stationary induction charging device 2, 2a to the mobile induction charging device 2, 2b during charging mode in order to charge a battery 102 of the motor vehicle 101. Accordingly, during charging mode, the stationary power coil 3, 3a serves as the primary coil 12 and the mobile power coil 3, 3b as the secondary coil 13. As can be seen from FIG. 1, in the exemplary embodiment shown, the mobile induction charging device 2, 2a has a rectifier 14 connected between the secondary coil 13 and the battery 102 in order to convert the alternating voltage induced in the secondary coil 13 into a rectified voltage. Furthermore, in the illustrated exemplary embodiments, the vertical direction 200 corresponds to the Z-direction of the motor vehicle 101. In addition, the longitudinal direction 201 and the transverse direction 202 correspond purely by way of example to the X-direction and the Y-direction of the motor vehicle 101.

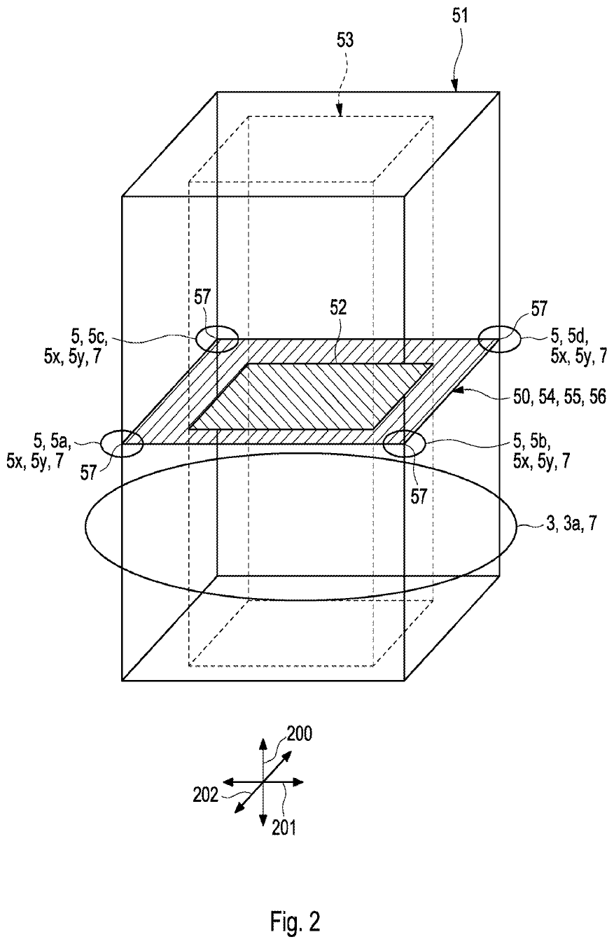

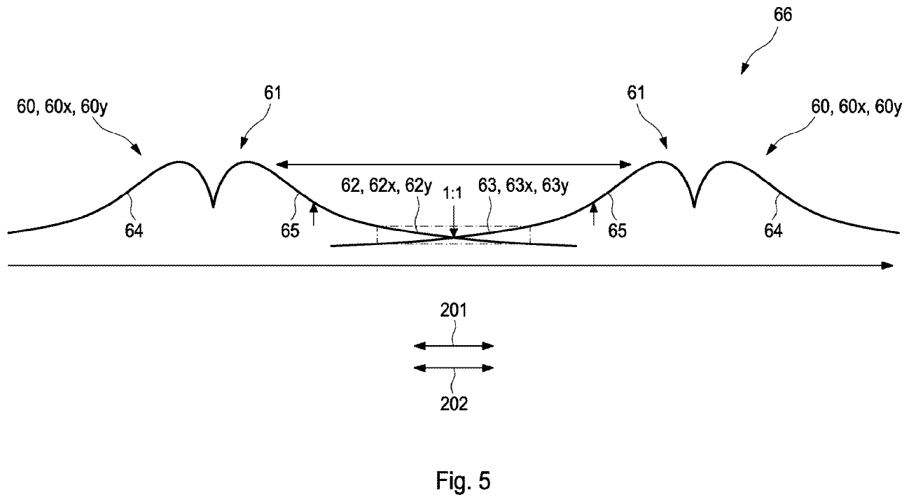

To detect the relative position of the power coils 3 to one another, at least two fields 60 are generated in one of the induction charging devices 2, which will be explained in more detail below with reference to FIG. 5. These fields 60 are also referred to below as positioning fields 60. The positioning fields 60 are generated in such a way that they can be distinguished from one another, and in such a way that the power coil 3 of the associated induction charging device 2 is fixedly positioned relative to the positioning fields 60. Furthermore, the positioning fields 60 are generated in such a way that the power coil 3 of the associated induction charging device 2 lies at least partially in a virtual volume 51 which is bounded by at least two intensity maximums 61 of at least two of the positioning fields 60 and extends in the vertical direction 200, which will be explained in more detail below with reference to FIG. 2. The volume 51 is also referred to below as the frame volume 51. The positioning fields 60 are received at least one position fixed with respect to the power coil 3 of the other induction charging device 2. In this case, a ratio range 63 (see FIG. 5) of at least two of the received positioning fields 60 is predetermined in advance, for which the power coil 3 of the induction charging device 2 receiving the positioning fields 60 is arranged in the frame volume 51. To determine the relative position of the power coils 3 to one another, the ratio 62 between at least two of the received positioning fields 60 is determined. If at least one of the at least one determined ratio 62 lies within the associated predetermined ratio range 63, it is recognized that the power coils 3 are arranged in the frame volume 51 and overlap transversely to the vertical direction 200. In the exemplary embodiments shown, the respective positioning field 60 is a magnetic positioning field 60. The respective ratio range 63 is preset by a fixed setting, so that the ratio range 63 is stored and calibration is not necessary.

In the exemplary embodiments shown, the respective positioning field 60 is generated with an associated coil 5, which will also be referred to below as the transmitting coil 5. In the exemplary embodiments shown, the respective positioning field 60 is received by at least one receiver 6, which interacts with the positioning fields 60 and, in the exemplary embodiments shown, is in the form of a coil 15, which is hereinafter referred to as a receiving coil 15. The transmitting coils 5 and the at least one receiving coil 15 can be components of a positioning device 4 of the system 1 (see FIG. 1).

As can be seen, for example, from FIG. 2, a total of four transmitting coils 5, namely a first transmitting coil 5, 5a, a second transmitting coil 5, 5b, a third transmitting coil 5, 5c and a fourth transmitting coil 5, 5d, are provided in the exemplary embodiments shown. Consequently, a total of four distinguishable positioning fields 60 are generated, namely a first positioning field 60, 60a, a second positioning field 60, 60b, a third positioning field 60, 60c and a fourth positioning field 60, 60d (see FIGS. 7 and 8). In the exemplary embodiments shown, a single receiver 6 is also provided for receiving the positioning fields 60. In the view shown in FIG. 1, only two of the transmitting coils 5 are visible. Due to the difference between the positioning fields 60, a distinction can be made between the positioning fields 60 by means of the at least one receiver 6.

In the exemplary embodiments shown, the positioning fields are generated in one of the induction charging devices and received in the other induction charging device. In the exemplary embodiments shown, the positioning fields 60 are generated in the mobile induction charging device 2, 2a and received in the stationary induction charging device 2, 2b. Accordingly, the stationary induction charging device 2, 2a has the transmitting coils 5 and the mobile induction charging device 2, 2b has the at least one receiver 6. In the exemplary embodiments shown, the transmitting coils 5 of the first power coil 3, 3a are different. In the exemplary embodiments shown, the at least one receiver coil 15 is, purely by way of example, different from the second power coil 3, 3b. As shown in FIG. 2, for example, the transmitting coils 5 are spaced apart and two of the transmitting coils 5 are arranged opposite each other.

In the exemplary embodiments shown, the transmitting coils 5 are identical, i.e. they are identical parts. In this case, the respective transmitting coil 5 is a flat coil 7 which has at least one conductor track, not explicitly shown, which is wound around an associated winding axis (not shown) running parallel to the vertical direction 200. The respective positioning field 60 thus has a main axis running along the vertical direction 200, and therefore develops at least predominantly in or along the vertical direction 200 and can thus only be received locally transversely to the vertical direction 200.

In the exemplary embodiments shown, the distinguishable generation of the positioning fields 60 is achieved by generating the respective magnetic positioning field 60 with an associated frequency. This means that the respective transmitting coil 5 is operated at an associated frequency so that the positioning fields 60 can be distinguished from one another. In particular, the frequencies lie in the range between 120 kHz and 145 kHz and are spaced apart from each other by a few Hz to kHz, for example. For example, the frequencies may be 5 kHz or 1 kHz or 100 Hz or less apart. Likewise, a distinction by means of duty cycles is possible.

FIG. 2 shows a schematic view in which only the transmitting coils 5 and the power coil 3 of the induction charging device 2 having the transmitting coils 5, in the illustrated exemplary embodiments thus the stationary power coils 3, 3a, of the system 1, are shown.

In the exemplary embodiments shown, the respective positioning field is generated by an associated transmitting coil 5, the geometric arrangements of the positioning fields 60 and the transmitting coils 5 are to be regarded as analogous. For example, the positioning fields 60 generated by two opposing transmitting coils 5 are parallel to the opposing arrangement of the transmitting coils 5, and the intensity maximums 61 are also parallel.

As can be seen from FIG. 2, the arrangement of the transmitting coils 5 is such that the transmitting coils 5 delimit a virtual frame The frame 50 is thus a virtual surface bounded by the transmitting coils 5. The virtual frame 50 defines the frame volume 51 that extends from frame 50 in the vertical direction 200. In this case, the power coil 3 of the associated induction charging device 2, in the illustrated exemplary embodiments thus the stationary power coil 3, 3a, is at least partially arranged in the virtual frame volume 51. The power coil 3 of the associated induction charging device 2 is thus either at least partially in the frame 50 or offset in the vertical direction 200 to the frame 50 and consequently arranged in the frame volume 51. In the exemplary embodiments shown, the transmitting coils 5 for the power coil 3 of the associated induction charging device 2 and thus for the stationary power coil 3, 3a in the vertical direction 200 are spaced apart. In the exemplary embodiments shown, two of the transmitting coils 5 are arranged opposite each other in the longitudinal direction 201 and in the transverse direction 202. The transmitting coils 5 lying opposite one another in the longitudinal direction 201 are also referred to below as longitudinal transmitting coils 5, 5x, and the transmitting coils 5 lying opposite one another in the transverse direction 202 are also referred to below as transverse transmitting coils 5, 5y. In the following, the positioning fields 60 generated by the longitudinal transmitting coils 5, 5x are also referred to as longitudinal positioning fields 60, 60x and the positioning fields 60 generated by the transverse transmitting coils 5, 5y are also referred to as transverse positioning fields 60, 60y.

As shown for example in FIG. 2, the transmitting coils 5 are arranged in the corners 57 of a rectangle 55 shaped quadrilateral 54 in the shown exemplary embodiments, so that the frame 50 has the shape of a rectangle 55. Thus, the frame volume 51 is cuboid. In the exemplary embodiment of FIG. 2, the frame 50 has the shape of a square 56. The arrangement of the transmitting coils 5 in the corners 57 of the rectangle 55 means that each transmitting coil 5 is both a longitudinal transmitting coil 5, 5x and a transverse transmitting coil 5, 5y. Thus, with the four transmitting coils 5, there are two pairs of transmitting coils 5 opposite each other in the longitudinal direction 201 and in the transverse direction 202. Similarly, the respective positioning field 60 is both a longitudinal positioning field 60, 60x and a transverse positioning field 60, 60y. Consequently, two pairs of intensity maximums 61 are arranged opposite each other in the longitudinal direction 201, spaced apart from each other, and two pairs of intensity maximums 61 are arranged opposite each other in the transverse direction 202, spaced apart from each other.

On the basis of the at least one determined ratio 62, it is also recognized whether the power coil 3 of the induction charging device 2, which has at least one receiver 6, is located within the virtual frame volume 51 and, depending on this, a positioning signal is output. In the exemplary embodiments shown, the at least one ratio 62 is thus used to recognize whether the mobile power coil 3, 3b is located within the frame volume 51 and is thus arranged above the stationary power coil 3, 3a in the vertical direction 200 and also at least partially overlaps with the stationary power coil 3, 3a transversely to the vertical direction 200.

As can be seen from FIG. 2, a virtual target range 52 is defined within the frame 50 in the exemplary embodiments shown. The target range 52 is thus smaller than the frame 50. In this process, the target range 52 defined a virtual volume 53 within the frame volume 51, which extends in the vertical direction 200 and is subsequently also referred to as the target volume 53 and is shown in FIG. 2 as a dashed line. The power coil 3 of the induction charging device 2 having the transmitting coils 5, in the illustrated exemplary embodiments thus the stationary power coil 3, 3a, is arranged at least partially in the target volume 53. In this case, the respective ratio range 63 is specified in such a way that the power coil 3 of the induction charging device 2 receiving the positioning fields 60 is arranged in the target volume 53.

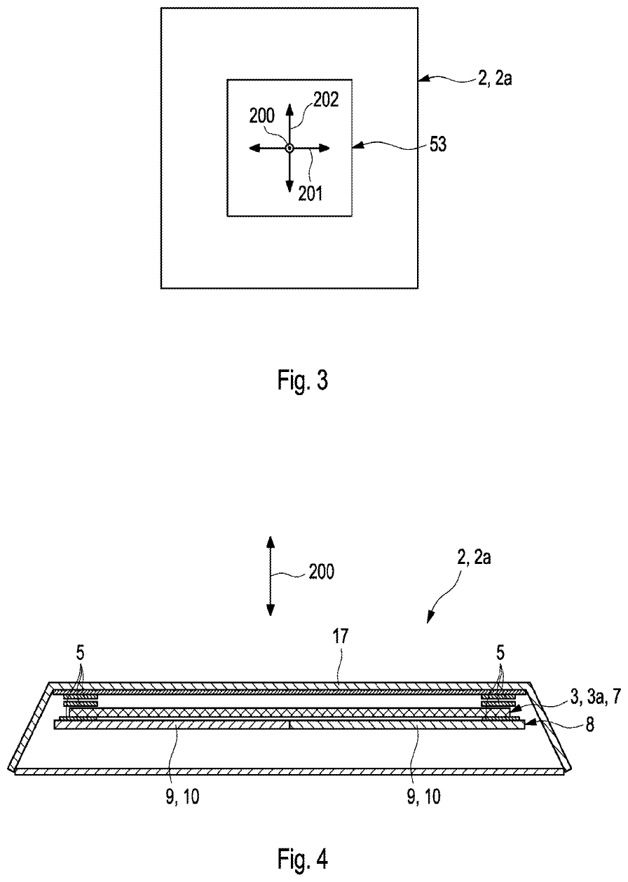

The frame volume 51 and the target volume 53 are defined in such a way that, with a corresponding arrangement of the power coils 3 in the frame volume 51 and in the target volume 53, a high degree of efficiency is achieved in the charging mode, for example at least 90%. The target volume 53 is chosen such that the efficiency is greater when both power coils 3 are arranged in the target volume 53 than when both power coils 3 are arranged in the frame volume 51. As indicated in FIG. 3, the target volume 53 in the projection in the vertical direction 200 and thus the target range 52 is smaller than the associated induction charging device 2, in the illustrated exemplary embodiments thus smaller than the stationary induction charging device 2, 2a.

The positioning signal can be used to move the application 100 manually or to move the application 100 autonomously. In the exemplary embodiment of the motor vehicle 101, the positioning signal can also be used to signal to an unseen driver whether the power coils 3 are aligned with each other as desired. For this purpose, the motor vehicle 101, as indicated in FIG. 1, can have an output device 103 that outputs corresponding signals.

The detection of the overlapping of the power coils 3 is explained in FIG. 5. FIG. 5 shows the course of two positioning fields 60, which are generated by means of two of the transmitting coils 5 located opposite each other in the longitudinal direction 201 or two of the transmitting coils 5 located opposite each other in the transverse direction 202. FIG. 5 shows the following positioning fields: 60 longitudinal positioning fields 60, 60x or transverse positioning fields 60, 60y. One of the positioning fields 60 is shown with a dashed line for better differentiation. FIG. 5 shows the intensity curve 64 of the longitudinal positioning fields 60, 60x along the longitudinal direction 201 and that of the transverse positioning fields 60, 60y along the transverse direction 202. According to FIG. 5, the positioning fields 60 of the opposing transmitting coils 5 in the target volume 53 coincide. As can be seen in FIG. 5, the positioning fields have 60 identical intensity curves 64. This means that the positioning fields are each generated with the same field distribution. Furthermore, in the exemplary embodiments shown, the transmitting coils 5 are designed and the positioning fields 60 are generated in such a way that the overall intensity curve 66 of the positioning fields 60 generated by the transmitting coils 5 is symmetrical between the opposing transmitting coils 5 and thus the intensity maximums 61 and with respect to the stationary power coil 3, 3b is symmetrical.

As can also be seen in FIG. 5, the respective positioning field 60 has an intensity curve 64 with intensity slopes 65 leading to an intensity maximum 61. As can also be seen from FIG. 5, the intensity maximums are spaced apart. The transmitting coils 5 are arranged accordingly and/or the positioning fields 60 are generated. As can also be seen in FIG. 5, the intensity maximum of the respective positioning field is shaped like a double hump. This is particularly due to the fact that the receiver 6, when positioned accordingly, detects a transition of the magnetic field lines not shown. As indicated in FIG. 5, the respective ratio range 62 between successive intensity slopes 65 of the positioning fields 60 generated by the opposing, associated transmitting coils 5 is arranged and spaced from the intensity maximums 61. In this case, for the longitudinal positioning fields 60, 60x with opposing intensity maximums 61 in the longitudinal direction 201, an associated longitudinal ratio range 63, 63x is predetermined in advance in each case, and for the transverse positioning fields 60, 60y with intensity maximums 61 lying opposite one another in the transverse direction 202, in each case an associated transverse ratio range 63, 63y is predetermined in advance. The predetermined ratio ranges 63 are preferably stored in such a way that a simple comparison between the determined ratio 62 and the associated ratio range 63 is used to detect whether there is a corresponding overlap between the power coils 3.

This means that the longitudinal transmitting coils 5, 5x are arranged and the longitudinal positioning fields 60, 60x are generated in such a way that the intensity maximums 61 of two longitudinal positioning fields 60, 60x are arranged opposite each other in the longitudinal direction 201. In this case, a corresponding longitudinal ratio range 63, 63x is specified in advance for at least two of the longitudinal positioning fields 60, 60x. A longitudinal ratio 62, 62x between at least two of the longitudinal positioning fields 60, 60x is determined from the longitudinal positioning fields 60, 60x received by means of the receiver 6. An overlap of the power coils 3, within the target volume 53 in the longitudinal direction 201 is detected when the determined longitudinal ratio 62, 62x is within the associated predetermined longitudinal ratio range 63, 63x. The same applies to the overlap in the transverse direction 202. This means that the transverse transmitting coils 5, 5y are arranged and/or the transverse positioning fields 60, 60y are generated in such a way that the intensity maximums 61 of two transverse positioning fields 60, 60y are arranged opposite each other in the transverse direction 202. Furthermore, an associated transverse ratio range 63, 63y is specified in advance for at least two of the transverse positioning fields 60, 60y. In positioning mode, a transverse ratio 62, 62y between at least two of the transverse positioning fields 60, 60y is determined from the transverse positioning fields 60, 60y received by the receiver 6. An overlap 3 of the power coils 3 within the target volume 53 in the transverse direction 202 is detected if the determined transverse ratio 62, 62y lies within the associated predetermined transverse ratio range 63, 63y. An overlap of the power coils 3 in the longitudinal direction 201 and in the transverse direction 202 is therefore present when at least one of the longitudinal ratios 62, 62y is within the longitudinal ratio range 63, 63y and at least one of the transverse ratios 62, 62y is within the transverse ratio range 63, 63y.

For example, for an overlap within the frame volume 51, a ratio range 63 between 10:0.05 to 0.05:10 may be given and for an overlap within the target volume 53, a ratio range 63 between 1:0.1 to 0.1:1 may be given.

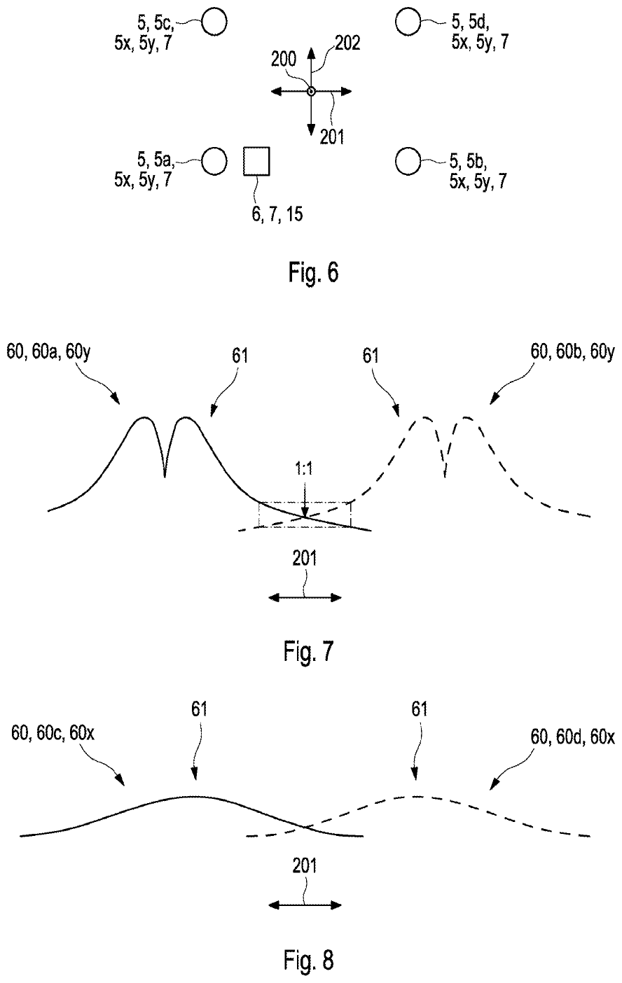

FIG. 6 shows a simplified top view of the transmitting coils 5 in the vertical direction 200. This assumes that the receiver 15 moves in the longitudinal direction 201 along the first transmitting coil 5, 5a and the second transmitting coil 5, 5b. FIG. 7 shows the positioning fields 60 of the first transmitting coil 5, 5a and the second transmitting coil 5, 5b received by the receiver 15 during this movement along the longitudinal direction 201, and thus the first positioning field 60, 60a and the second positioning field 60, 60b. FIG. 8 shows the positioning fields 60 of the third transmitting coil 5, 5c and the fourth transmitting coil 5, 5b and thus the fourth positioning field 60, 60c and the fourth positioning field 60, 60d received during this movement of receiver 15 along longitudinal direction 201. The first positioning field 60, 60a and the second positioning field 60, 60b are longitudinal positioning fields 60, 60x in relation to each other. Similarly, the third positioning field 60, 60c and the fourth positioning field 60, 60d are longitudinal positioning fields 60, 60 x in relation to each other. As can be seen from a comparison of FIGS. 7 and 8, the double hump shape of the positioning fields 60 received by the receiver 15 is more pronounced for the positioning fields 60 close to the receiver 15 than for the positioning fields 60 further away from the receiver 15. In the example described, the double hump shape is more pronounced for the received first positioning field 60, 60a and second positioning field 60, 60b than for the received third positioning field 60, 60c and fourth positioning field 60, 60d. For a better understanding, FIG. 8 does not show the double hump shape of the more distant positioning fields 60, in this example the third positioning field 60, 60c and the fourth positioning field 60, 60d. Accordingly, the ratio 62 of the two positioning fields 60 exhibiting the opposite intensity maximums 61 is determined favorably and, in the event of a deviation of the ratios 62 above a predetermined limit value, the ratio 62 of the positioning fields 60 with the lower intensity is used to recognize the relative position. Consequently, those positioning fields 60 are used whose determined ratio 62 is further away from the intensity maximums 61. This is particularly important to prevent the double hump shape of the intensity maximums described above from leading to a false recognition of the position. If, on the other hand, the two ratios 62 essentially correspond to each other, i.e. if the ratios 62 are essentially the same or within a predetermined range of values, the two ratios 62 are averaged to determine the relative position.

In the event of a deviation of the determined ratio 62 from the associated ratio range 63 towards an intensity maximum 61 of one of the associated positioning fields 60, an offset of the power coil 3 of the receiving and thus receiving and thus the receiver 6 having induction charging device 2 towards that intensity maximum 61 and thus towards the transmitting coil 5 generating the intensity maximum 61, to which the ratio 62 is shifted. In other words, if the determined longitudinal ratio 62, 62x of the associated longitudinal ratio range 63, 63x is shifted towards one of the intensity maximums 61 of one of the associated longitudinal positioning fields 60, 60x, this means that there is an offset of the mobile power coil 3, 3 b out of the target volume 53 along the longitudinal direction 201 towards that longitudinal transmitting coil 5, 5x which generates the longitudinal positioning field 60, 60x with that intensity maximum 61 towards which the determined longitudinal ratio 62, 62x is shifted. The same applies to the determined transverse ratio 62, 62y. This means that if the determined transverse ratio 62, 62y of the associated transverse ratio range 63, 63y is shifted towards one of the intensity maximums 61 of one of the associated transverse positioning fields 60, 60y, this indicates that there is an offset of the mobile power coil 3, 3b out of the target volume 53 along the transverse direction 202 towards that transverse transmitting coil 5, 5y which generates the transverse positioning field 60, 60y with that intensity maximum 61 towards which the determined transverse ratio 62, 62y is shifted. Thus, navigation of the mobile induction charging device 2, 2a can be realized in such a way that an overlap of the two power coils 3 in the target volume and thus both in the longitudinal direction 201 and in the transverse direction 202 is achieved. As indicated in FIG. 1, this can be done by means of the output device 103, in order to output whether and in which direction a relative movement of the mobile induction charging device 2, 2b relative to the stationary induction charging device 2, 2a is necessary to achieve an overlap of the power coils 3 in the longitudinal direction 201 and in the transverse direction 202. In the exemplary embodiment shown in FIG. 1, this is done purely exemplarily optically by means of the display of arrows indicated in FIG. 1. It is also conceivable that the output device 103 emits an acoustic signal. It is also conceivable to implement the result autonomously so that the motor vehicle 101 is driven autonomously in order to achieve an overlap of the power coils 3.

Maximized charging efficiency is achieved when the power coils 3 are in a specific relative position to one another, which will be referred to below as the “centered arrangement”. The centered arrangement is assigned to a ratio 63 within the ratio ranges 63. This means that for a given centering-to-length ratio in the longitudinal ratio range 63, 63x, the power coils 3 are arranged in a centered manner in the longitudinal direction 201. In addition, for a given centering-to-transverse ratio in the transverse ratio range 63, 63y, the power coils 3 are arranged centered in relation to each other in the transverse direction 202. An overall centered arrangement is thus present if at least one of the determined longitudinal ratios 62, 62x corresponds to the associated centering-to-length ratio and at least one of the determined transverse ratios 62, 62y corresponds to the associated centering-to-transverse ratio. The respective centering ratio in the exemplary embodiments shown is 1:1, as indicated in FIG. 5. Analogous to the above explanation, it is possible to implement a navigation system in such a way that the power coils 3 are arranged in a centered manner overall.

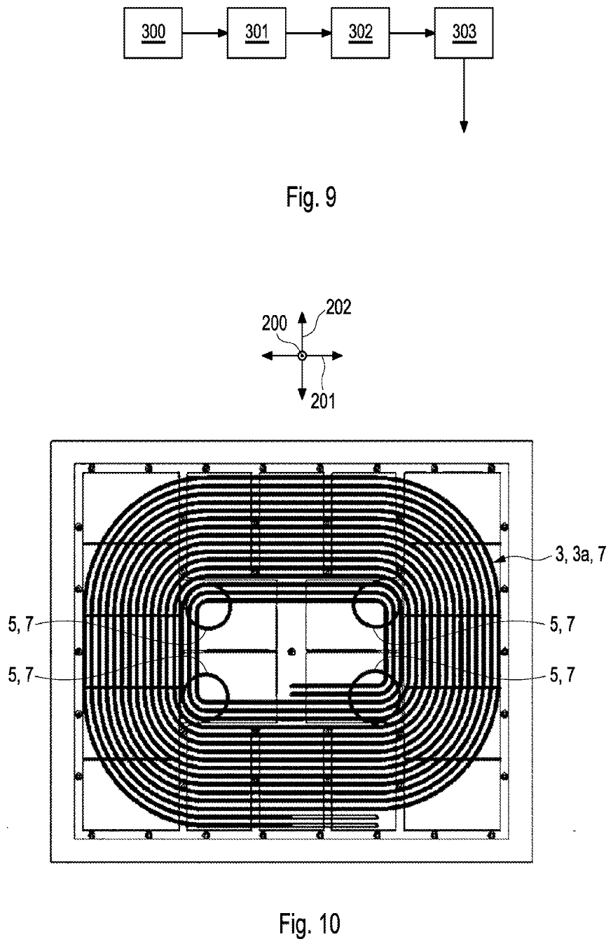

FIG. 9 shows a flowchart explaining how the relative position of the power coils 3 to one another is recognized. The positioning operation is triggered when the application 100 and thus the mobile induction charging device 2, 2b approaches the stationary induction charging device 2, 2a. This is the case, for example, when the distance between two induction charging devices 2 at right angles to the vertical direction is less than 1.5 m, in particular less than 1 m, preferably less than 0.5 m. The initiation of the positioning operation can be done, for example, by means of a ping signal emitted by the mobile induction charging device 2, 2b, upon receipt of which the mobile induction charging device 2, 2a generates the positioning fields 60 with the transmitting coils 5. According to FIG. 9, in a method measure 300, which is also referred to below as receiving measure 300, the positioning fields 60 receive by the receiver 6 and separate from one another in a subsequent method measure 301 in such a way that the intensity of the positioning fields 60 can be distinguished from one another. In particular, in method measure 301, a Fourier transformation is carried out on the signals received by receiver 6, i.e. in the case of receiving coil 15, the voltages induced in receiving coil 6 by the positioning fields 60. The method measure 301 is also referred to below as the 301 separation measure. The result of separation measure 301 is thus a value associated with the respective positioning field 60, so that a total of four values are present. The associated longitudinal ratios 62, 62x and transverse ratios 62, 62y are determined from these values in a method measure 302 for the longitudinal positioning fields 60, 60x and for the transverse positioning fields 60, 60y. In this case, it is advantageous to average over several values, for example over the last ten values determined, in order to increase the accuracy of the method and/or to reduce the susceptibility to errors. Method measure 302 will also be referred to below as ratio measure 302. The ratios 102 determined in the ratio measure 62 are compared in a method measure 303 with the corresponding predefined ratio ranges 63 and, on the basis of the comparison, it is determined whether there is a corresponding overlap of the power coils 3, i.e. the arrangement of the mobile power coil 3, 3b within the target volume 53. Method measure 303 is also referred to below as comparison measure 303. As indicated in FIG. 9, the comparison measure 303 outputs at least one positioning signal. As explained above, the positioning signal is used primarily for navigating the mobile application 100. Accordingly, the positioning signals of the output device can be made available.

A suitably designed control device 16, as shown in a simplified form in FIG. 1, can be used to detect the relative position. The control unit 16 can be part of the positioning device 4, the system 1 or the application 100. The method can be carried out by means of a computer program product.

According to FIG. 4, the induction charging device 2 comprising the transmitting coils 5, in this case the stationary induction charging device 2, 2a, has a flat coil 7 as the power coil 3 in the exemplary embodiments shown, which is larger than the transmitting coils 5. In addition, the stationary induction charging device 2, 2a has a magnetic flux guide unit 8 for guiding the alternating field generated by the stationary power coil 3, 3a during charging mode. For this purpose, the magnetic flux guide unit 8 has magnetic flux guide elements 9 in the illustrated exemplary embodiments, which are designed as ferrite plates 10. The transmitting coils 5 overlap the stationary power coil 3, 3a and are arranged in the corners 57 of a rectangle 55 (see, for example, FIG. 2) and in a plane parallel to the stationary power coil 3, 3a. Furthermore, the transmitting coils 5 are arranged above the magnetic flux guide unit 9.

FIG. 4 shows possible relative positions of the transmitting coils 5 to the stationary power coil 3, 3a. Accordingly, the transmitting coils 5 can be arranged in the vertical direction 200 between the stationary power coil 3, 3a and the magnetic flux guide unit 8, on the side of the magnetic flux guide unit 8 facing away from the stationary power coil 3, 3a or on the side of a foreign object detection device 17 of the stationary induction charging device 2, 2a facing the stationary power coil 3, 3a.

FIG. 10 shows a further exemplary embodiment which differs from the preceding exemplary embodiments in that the transmitting coils 5 are arranged in an inwardly offset manner.

1. A method for detecting the relative position of a stationary induction charging device to a mobile induction charging device, the stationary induction charging device including a stationary power coil and the mobile induction charging device including a mobile power coil, when in a charging mode of the system, one of the stationary power coil and the mobile power coils providing an alternating magnetic field which induces a voltage for energy transmission in the other of the stationary power coil and the mobile power coil, the stationary power coil and the mobile power coil spaced apart from one another in a vertical direction in the charging mode, the method comprising:
providing at least two positioning fields in a first induction charging devices such that the at least two positioning fields are distinguishable from one another and a first power coil of the first induction charging device is fixedly positioned relative to the at least two positioning fields, the first power coil disposed at least partially in a virtual frame volume is bounded by at least two intensity maximums of the at least two positioning fields and extending in the vertical direction;
receiving the at least two positioning fields at at least one position that is fixed with respect to a second power coil of a second induction charging device;
a ratio range of the at least two received positioning fields is predetermined in advance, for which the second power coil of the second induction charging device receiving the at least two positioning fields is arranged in the virtual frame volume;
determining a ratio between the at least two received positioning fields; and
recognizing that the first power coil and the second power coil are arranged in the virtual frame volume and overlap transversely to the vertical direction when the determined ratio lies within the predetermined ratio range;
wherein the first induction charging device and the first power coil are one of i) the stationary induction charging device and the stationary power coil, respectively, and ii) the mobile induction charging device and the mobile power coil, respectively; and
wherein the second induction charging device and the second power coil are the other one of i) the stationary induction charging device and the stationary power coil, respectively, and ii) the mobile induction charging device and the mobile power coil, respectively.

2. The method according to claim 1, wherein:
within the virtual frame volume, a virtual target volume extending in the vertical direction is defined such that the first power coil is arranged at least partially in the virtual target volume; and,
the ratio ranges is specified such that the second power coil is arranged in the virtual target volume.

3. The method according to claim 1, wherein:
providing the at least two positioning fields includes providing at least two longitudinal positioning fields each having a respective intensity maximum;
the at least two longitudinal positioning fields are provided such that the intensity maximums of the at least two longitudinal positioning fields are arranged opposite each other in a longitudinal direction extending transversely to the vertical direction;
for the at least two longitudinal positioning fields, a longitudinal ratio range is specified in advance; and
the method further comprises:
determining a longitudinal ratio between the at least two longitudinal positioning fields from the at least two received longitudinal positioning fields; and
recognizing that the first power coil and the second power coil overlap in the longitudinal direction when the determined longitudinal ratio lies within the predetermined longitudinal ratio range.

4. The method according to claim 1, wherein:
providing the at least two positioning fields includes providing at least two transverse positioning fields each having a respective intensity maximum;
the at least two transverse positioning fields are provided such that the intensity maximums of the at least two transverse positioning fields are arranged opposite one another in a transverse direction extending transversely to the vertical direction;
for the at least two transverse positioning fields, a transverse ratio range is specified in advance; and
the method further comprises:
determining a transverse ratio between the at least two transverse positioning fields from the at least two received transverse positioning fields; and
detecting that the first power coil and the second power coil overlap in the transverse direction when the determined transverse ratio lies within the predetermined transverse ratio range.

5. The method according to claim 1, wherein:
providing the at least two positioning fields includes providing a plurality of positioning fields each having a respective intensity maximum, the plurality of positioning fields including a plurality of longitudinal positioning fields and a plurality of transverse positioning fields;
the intensity maximums of at least two longitudinal positioning fields of the plurality of longitudinal positioning fields are arranged opposite one another in a longitudinal direction extending transversely to the vertical direction;
a predetermined longitudinal ratio range for the at least two longitudinal positioning fields is specified in advance;
the intensity maximums of at least two transverse positioning fields of the plurality of transverse positioning fields are arranged opposite one another in a transverse direction extending transversely to the vertical direction and to the longitudinal direction;
a predetermined transverse ratio range for the at least two transverse positioning fields is specified in advance; and
the method further comprises:
determining a longitudinal ratio between the at least two longitudinal positioning fields from the at least two received longitudinal positioning fields;
determining a transverse ratio between the at least two transverse positioning fields from the at least two received transverse positioning fields; and
detecting that the first power coil and the second power coil overlap when:
the determined longitudinal ratio lies within the associated predetermined longitudinal ratio range; and
the determined transverse ratio lies within the predetermined transverse ratio range.

6. The method according to claim 1, wherein:
a longitudinal direction extends transversely to the vertical direction;
a transverse direction extends transversely to the vertical direction and to the longitudinal direction;
providing the at least two positioning fields includes providing a plurality of positioning fields each having a respective intensity maximum; and
the plurality of positioning fields are provided such that at least one of:
two mutually spaced pairs of the intensity maximums are arranged opposite one another in the longitudinal direction; and
two mutually spaced pairs of the intensity maximums are arranged opposite one another in the transverse direction.

7. The method according to claim 6, further comprising:
determining a first ratio between a first set of two positioning fields having the opposing intensity maximums;
determining a second ratio between a second set of two positioning fields having the opposing intensity maximums; and
when a deviation the first ratio and the second ratio is above a predetermined limit value, detecting a relative position using the ratio of the set of two positioning fields with the lower intensity maximum.

8. The method according to claim 7, further comprising, when the first ratio and the second ratio match within a range of values, recognizing the relative position using an average of the first ratio and the second ratio 2) are averaged in order to recognize the relative position.

9. The method according to claim 1, further comprising, when the determined ratio deviates from the predetermined ratio range towards intensity maximum of one of the associated positioning fields, detecting an offset of the second power coil with respect to the first power coil in a direction toward the intensity maximum to which the determined ratio is offset.

10. The method according to claim 1, further comprising outputting a positioning signal depending on a determined value of the determined ratio relative to the predetermined ratio range.

11. The method according to claim 10, further comprising utilizing the positioning signal to navigate the mobile induction charging device to an overlapping arrangement of the mobile power coil and the stationary power coil, wherein the positioning signal is utilized at least one of:
via an output device as a guide for navigating the mobile induction charging device; and
as a control signal for an automated navigation of the mobile induction charging device.

12. The method according to claim 5, wherein the plurality of positioning fields are provided such that at least one of:
for a given centering-to-length ratio in the predetermined longitudinal ratio range, the first power coil and the second power coil are arranged in a centered manner in the longitudinal direction; and
for a given centering-to-transverse ratio in the predetermined transverse ratio range, the first power coil and the second power coil are arranged centered in relation to one another in the transverse direction.

13. The method according to claim 1, wherein the at least two positioning fields are provided such that the ratio ranges is spaced apart from the intensity maximums of the associated positioning fields.

14. The method according to claim 1, wherein the at least two positioning fields have the same intensity curves.

15. The method according to claim 1, wherein the at least two positioning fields are provided such that an overall intensity curve of the at least two positioning fields is symmetrical with respect to the first power coil.

16. The method according to claim 1, wherein the at least two positioning fields are provided at different frequencies such that the at least two positioning fields are distinguishable in the second induction charging device.

17. The method according to claim 1, wherein the at least two positioning fields are provided with respective associated degrees of scanning such that the at least two positioning fields are distinguishable.

18. The method according to claim 1, wherein the stationary induction charging device is the first induction charging device and the mobile induction charging device is the second induction charging device.

19. The method according to claim 1, wherein the mobile induction charging device is the first induction charging device and the stationary induction charging device is the second induction charging device.

20. The method according to claim 1, wherein at least one of the at least two positioning fields is a magnetic positioning field.

21. The method according to claim 1, wherein each positioning field of the at least two positioning fields has a main axis extending along the vertical direction.

22. A computer program product configured to carry out the method according to claim 1.

23. A system comprising a stationary induction charging device, a mobile application including a mobile induction charging device, and a control device, wherein:
the stationary induction charging device includes a stationary power coil;
the mobile induction charging device has includes a mobile power coil;
the stationary power coil and the mobile power coil are spaced apart in a vertical direction relative to one another when in a charging mode and interact inductively to transfer energy inductively to the mobile application;
one of the stationary induction charging device and the mobile induction charging devices includes at least two transmitting coils that provide a plurality of positioning fields that are distinguishable from one another in a positioning operation;
the other of the stationary induction charging device and the mobile induction charging device includes at least one receiver for receiving the plurality of positioning fields; and
the control device is configured to operate the system in the positioning mode according to the method of claim 1.

24. A mobile application, comprising a mobile induction charging device for a system according to claim 21.

25. A stationary induction charging device of a system according to claim 21.
